(19) United States
(12) Patent Application Publication
(10) Pub. No.: US 2017/0346724 A1
(43) Pub. Date: Nov. 30, 2017

(54) DYNAMIC MULTI-PATH CONTROL AND ADAPTIVE END-TO-END CONTENT DELIVERY OVER WIRELESS MEDIA

(71) Applicants: Doru CALIN, Manalapan, NJ (US); Hyunwoo NAM, New York, NY (US)

(72) Inventors: Doru CALIN, Manalapan, NJ (US); Hyunwoo NAM, New York, NY (US)

(21) Appl. No.: 15/392,137

(22) Filed: Dec. 28, 2016

Related U.S. Application Data
(60) Provisional application No. 62/341,351, filed on May 25, 2016.

(51) Int. Cl. H04L 12/707; H04L 12/26; H04L 12/801; H04W 28/02; H04W 40/12; H04W 84/12

(52) U.S. Cl. CPC H04L 45/24; H04W 28/0236; H04W 40/12; H04L 43/0882; H04L 47/18; H04L 43/0888; H04W 84/12

(57) ABSTRACT

A radio access network element includes at least one transceiver coupled to at least one processor. The at least one processor configured to execute computer readable instructions to: determine a first available throughput for a first path traversing a first wireless network; determine a second available throughput for a second path traversing a second wireless network; and establish, for at least one packet communication protocol connection, at least one of a first multipath packet flow via the first path and a second multipath packet flow via the second path based on (i) a throughput gap threshold value and (ii) a throughput gap parameter for the first and second paths, the throughput gap parameter indicative of a difference between the first available throughput and the second available throughput.

### CROSS-REFERENCE TO RELATED APPLICATION(S)

This non-provisional U.S. patent application claims priority under 35 U.S.C. §119(e) to provisional U.S. patent application No. 62/341,351, filed May 25, 2016, the entire contents of which are incorporated herein by reference.

### BACKGROUND

### Field

One or more example embodiments relate to communication systems, for example, Software Defined Networking (SDN) and/or Network Function Virtualization.

### Discussion of Related Art

Related art multi-homed devices may be connected to multiple network interfaces. For instance, a smartphone may be attached to mobile network (e.g., third generation (3G) and fourth generation (4G) mobile technologies) and a wireless local area network (WLAN), such as, Wi-Fi network, for Internet access. A router in a Wide Area Network (WAN) may also be connected to multiple Internet Service Providers (ISPs).

An advantage of using multi-homed devices is that when an interface is down, Internet connectivity may still be possible through other interfaces. However, with regular Transmission Control Protocol (TCP), the multi-homed devices cannot use multiple interfaces simultaneously for a single TCP connection. As a result, when an interface currently in use goes down, the application must re-establish a new TCP session via another interface for continuity of service and bandwidth aggregation.

Multi-Path TCP (MPTCP) is a TCP extension that allows end-hosts (e.g., multi-homed devices) to use multiple paths together to maximize network utilization and increase redundancy. MPTCP may be implemented in modern operating systems and existing applications without using excessive memory or processing.

As is generally known, MPTCP uses multiple paths concurrently and/or simultaneously for a single TCP connection. This use of multiple paths may cause a relatively large number of out-of-order TCP packets, especially when the paths have different bandwidths and delays. For instance, if a packet arrives at the receiver's buffer over a WLAN while other packets with lower sequence numbers are delayed and still arriving through a mobile network due to congestion, then MPTCP holds the packet received via the WLAN in the reordering queue until its data sequence number is in order. In this case, performance using MPTCP may be degraded.

### SUMMARY

At least one example embodiment provides a radio access network element comprising: at least one transceiver and at least one processor. The at least one transceiver is configured to transmit and receive content associated with at least one packet communication protocol connection traversing at least a first wireless network and a second wireless network. The at least one processor is coupled to the at least one transceiver, and is configured to execute computer readable instructions to: determine a first available throughput for a first path traversing the first wireless network; determine a second available throughput for a second path traversing the second wireless network; establish, for the at least one packet communication protocol connection, at least one of a first multipath packet flow via the first path and a second multipath packet flow via the second path based on (i) a throughput gap threshold value and (ii) a throughput gap parameter for the first and second paths, the throughput gap parameter indicative of a difference between the first available throughput and the second available throughput.

At least one other example embodiment provides a radio access network element comprising: at least one transceiver and at least one processor. The at least one transceiver is configured to receive content associated with at least one packet communication protocol connection via at least a first connectivity path through a first wireless edge node and a second connectivity path through a second wireless edge node. The at least one processor is coupled to the at least one transceiver, and is configured to execute computer readable instructions to: compute at least one throughput gap parameter for the first and second connectivity paths based on a maximum throughput supported by each of the first and second wireless edge nodes and a maximum throughput across the first and second connectivity paths; and selectively enable and disable at least one of the first and second connectivity paths for receiving the content associated with the at least one packet communication protocol connection based on the computed at least one throughput gap parameter and a throughput gap threshold value for the at least one packet communication protocol connection.

At least one other example embodiment provides a radio access network element comprising: at least one transceiver and at least one processor. The at least one transceiver is configured to receive content associated with at least one packet communication protocol connection via at least a first connectivity path through a first wireless edge node and a second connectivity path through a second wireless edge node. The at least one processor is coupled to the at least one transceiver, and is configured to execute computer readable instructions to: compute a first throughput gap parameter for the first connectivity path based on a first expected throughput and a first maximum throughput supported by the first wireless edge node; compute a second throughput gap parameter for the second connectivity path based on a second expected throughput and a second maximum throughput supported by the second wireless edge node; and selectively enable and disable at least one of the first and second connectivity paths for receiving the content associated with the at least one packet communication protocol connection based on the computed first and second throughput gap parameters and a throughput gap threshold value for the at least one packet communication protocol connection.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 is a signal flow diagram illustrating a method for establishing Transmission Control Protocol (TCP) sessions between a client device and a server over two paths using Multi-Path Transmission Control Protocol (MPTCP);

FIG. 2 shows a Software Defined Networking (SDN) framework and platform according to example embodiments.

FIG. 3 illustrates a portion of an SDN framework and platform, according to example embodiments.

FIGS. 4A and 4B are flow charts illustrating an example embodiment of connectivity path control method;

FIG. 5 is a flow chart illustrating an example embodiment of a method for disabling the j-th connectivity path.

FIG. 6 provides a general architecture and functionality suitable for implementing functional elements described herein or portions of functional elements described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing base stations, NodeBs, eNodeBs, gateways, servers, etc. Such existing hardware may include one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

As used herein, the term “eNodeB” or “eNB” may be considered synonymous to, and may hereafter be occasionally referred to as a NodeB, base station, transceiver station, base transceiver station (BTS), etc., and describes a transceiver in communication with and providing wireless resources to users in a geographical coverage area. As discussed herein, eNBs may have all functionally associated with conventional, well-known base stations in addition to the capability and functionality to perform the methods discussed herein.

The term “client device” as discussed herein, may be considered synonymous to, and may hereafter be occasionally referred to, as user equipment (UE), user, user device, client, mobile unit, mobile station, mobile user, mobile, subscriber, remote station, access terminal, receiver, etc., and describes a remote user of wireless resources in one or more wireless communication networks (e.g., 3G mobile networks, 4G mobile networks, 5G mobile networks, WLANs, etc.).

As discussed herein, application servers may be web servers that host multimedia content (e.g., voice, video, etc.), Voice over Internet Protocol (VoIP) servers providing VoIP services to users in a network, a web server, an instant messaging server, an email server, a software and/or cloud server, or any other Internet Protocol (IP)-based service deliverable to a mobile or other device using 3GPP access and/or non-3GPP access (e.g., WLAN, Wi-Fi, etc.). In this regard, downlink bearer traffic may include, for example, webpages, videos, emails, instant messages, a direction of a VoIP call, a direction of a video call, or the like, which originates at an application server. Uplink bearer traffic may include requests for webpages, requests for video, emails, instant messages, a direction of a VoIP call, a direction of a video call, upload of a video, or the like.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

According to example embodiments, routers, client devices, UEs, eNBs, WLAN APs, application servers, etc. may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

The client devices, eNBs, WLAN APs, application servers, etc., discussed herein, may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more switches, gateways, MMEs, controllers, other eNBs, client devices, etc. As discussed herein, a client device and/or eNB may be referred to as a radio access network (RAN) device, element or entity.

For simplicity and consistency, in some cases, the technological terms used herein refer to the 3d Generation Partnership Project Long Term Evolution (3GPP LTE or LTE) and Multi-Path Transmission Control Protocol (MPTCP) technology, but can be generalized for any wireless technology. Although discussed herein with regard to these technologies, it should be understood that example embodiments may be applicable to any multi-connectivity transport protocol providing connectivity to wireless devices over multiple interfaces (e.g., User Datagram Protocol (UDP)).

As is generally well-known, Multi-Path TCP (MPTCP) is implemented at the transport layer (Internet layer 4), and supports both IPv4 and IPv6. A subflow is a TCP flow on an individual connectivity path that may be defined by a 4-tuple (source and destination IP addresses and TCP port pairs). MPTCP establishes and terminates a subflow similar to regular TCP, but does not attach multiple subflows at the same time.

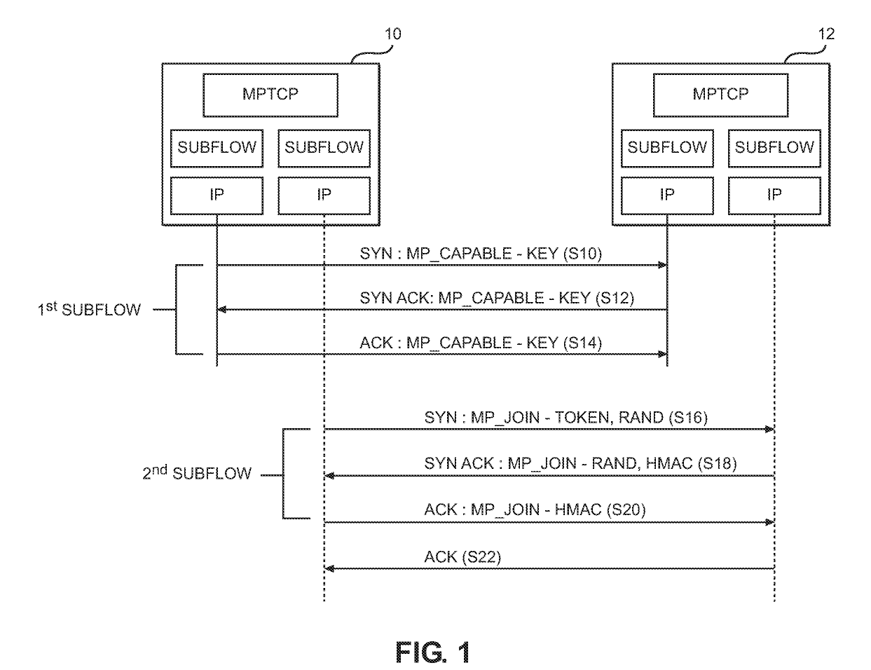

FIG. 1 is a signal flow diagram illustrating a method for establishing TCP sessions between a client device 10 and a server 12 over two connectivity paths using MPTCP.

Referring to FIG. 1, during a handshake procedure, at step S10 the client device 10 sends a SYN message segment (also referred to herein as a segment) that contains the MP CAPABLE option to the server 12. The MP CAPABLE option indicates that the client device 10 is MPTCP capable. In one example, the client device 10 may indicate the MP CAPABLE option using a flag bit.

If the server 12 supports MPTCP, then the server 12 replies to the SYN segment by sending a SYN ACK message, including the MP CAPABLE option, to the client device 10 at step S12. The MP CAPABLE option in the SYN ACK message indicates that the server 12 supports MPTCP. The server 12 may indicate the MP CAPABLE option using a flag bit.

At step S14, the client device 10 confirms the MPTCP connection by sending an ACK with the MP CAPABLE option back to the server 12.

During the handshake, both the client device 10 and the server 12 exchange random keys (KEY in FIG. 1), which are used to generate a token. The token is used for authentication when adding a new subflow to the MPTCP connection.

To attach a second subflow to the MPTCP connection, the client device 10 and the server 12 use the MP JOIN option during a subsequent handshake. The client device 10 and the server 12 also exchange random nonces RAND that are used to compute hash-based message authentication codes (HMACs).

In more detail with regard to FIG. 1, to add a second subflow to the MPTCP connection, at step S16 the client device 10 sends a SYN message segment to the server 12. In this case, the SYN message segment includes the MP JOIN option, the token generated using the random keys and the random nonces RAND as discussed above. As with the MP CAPABLE option, the MP JOIN option may be indicated via a flag bit.

In response to receiving the SYN message segment, the server 12 responds to the SYN message segment by sending a SYN ACK message including the MP JOIN option to the client device 10 at step S18. The server 12 may indicate the MP JOIN option using a flag bit. The SYN ACK message from the server 12 also includes the above-discussed random nonces RAND and HMACs.

At step S20, the client device 10 confirms the new subflow by sending an ACK with the MP JOIN option back to the server 12. The ACK message also includes the above-discussed HMACs.

In response to the ACK message from the client device 10, the server 12 sends a final ACK message to the client device 10 at step S22. The final ACK at step S22 is a confirmation message received by the client device 10 from the server 12, containing the HMAC and ACK messages.

Once the two subflows are established, the client device 10 and the server 12 may use the subflows to exchange data concurrently and/or simultaneously. The default scheduler for the MPTCP connection pushes data through the subflow with the lowest Round Trip Time (RTT) as long as there is space in the congestion window for the subflow. If the congestion window is full, then the scheduler moves onto the next subflow with the next highest RTT. Each subflow uses its own TCP sequence numbers, and the MPTCP uses the sequence numbers to ensure that the packets received via the two subflows are delivered to the application layer in order. When packet loss occurs on a subflow, the packet can be retransmitted over another subflow. When one subflow fails, MPTCP may use the other subflow to convey the failure to the other host.

Conventional MPTCP solutions, such as that discussed above with regard to FIG. 1, may suffer from relatively poor performance when a relatively large number of out-of-order packets are delivered through parallel TCP paths. This typically occurs when various connectivity paths are subject to different bandwidth and delay characteristics. Such unbalanced link conditions are more likely to occur in mobile environments, when a client device is moving around and signal strength varies accordingly. In one example, this may be the case when a packet has arrived at the client device's buffer over an available interface (e.g., a mobile network such as 3^{rd} Generation Partnership Project Long-Term Evolution (3GPP LTE)) while several other packets with lower sequence numbers are still arriving at the client device's buffer through another available interface (e.g., via a wireless local area network (WLAN) such as a Wi-Fi network) due to network congestion. In this example, the client device holds the packet in the reordering queue until the data sequence number of the packet is in order, which may degrade the throughput performance significantly.

According to at least some example embodiments, a MPTCP client device monitors current downloading rates on connectivity paths for a given subflow to identify and/or detect relatively poor links that may cause an increase of the reordering queue size at the MPTCP layer at the client device. Upon detecting the relatively poor links, the client device may remove (e.g., temporarily remove) the connectivity path that performs relatively poorly, and re-attach the connectivity path when sufficiently large throughput becomes available. According to at least some example embodiments, the client device may obtain the estimated capacity over the path through an SDN controller.

The number of connectivity paths and/or traffic flows between an application server and a client device may be dynamically adjusted (e.g., added or removed) through the use of a Software-Defined Networking (SDN) framework applicable to client devices. In at least one example embodiment, SDN applications installed on a client device (e.g., a user equipment (UE) or other multi-homed device) and wireless edge nodes (e.g., eNBs, WLAN APs, etc.) track available capacity of various connectivity paths (e.g., all or a subset) between the application server and client devices in real-time, and enable selection of the most appropriate connectivity paths, depending on varying network conditions, which may be triggered either by network events, or simply by mobility of a client device.

According to at least one example embodiment, number of parallel paths in a multi-connectivity protocol (e.g., connectivity paths in MPTCP, UDP, etc.) may be dynamically adjusted with the support of an SDN framework. According to at least one example embodiment, an SDN framework may be configured to: (1) recognize heavily unbalanced traffic load conditions; and/or (2) determine when and how to adjust the number of connectivity paths during traffic downloads.

According to at least one example embodiment, a threshold is used to identify unbalanced traffic load conditions, which may trigger multi-connectivity protocols to behave relatively poorly. An SDN application at multi-connectivity client device monitors the current throughput on connectivity paths to identify relatively poor links that increase the reordering queue size at the multi-connectivity protocol (e.g., MPTCP, UDP, etc.) layer at the client device. The SDN application at the client device obtains the estimated capacity over a connectivity path between the application server and the client device through an SDN controller, and removes the connectivity path(s) with lower capacity relative to other available connectivity paths. The SDN application attaches those connectivity path(s) again when a sufficiently large capacity becomes available.

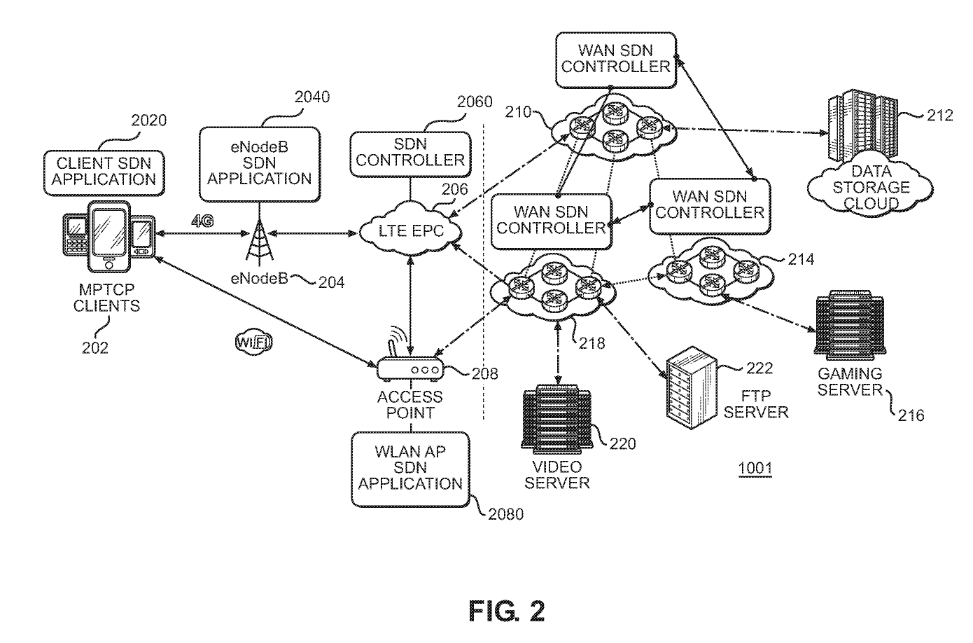

FIG. 2 illustrates an SDN framework and platform in accordance with example embodiments.

Referring to FIG. 2, multi-connectivity client devices (e.g., MPTCP client devices) 202 are served by an eNB 204 and a wireless local area network (WLAN) access point (AP) 208. As is generally known, the eNB 204 is part of what is referred to as an Evolved Universal Mobile Telecommunications System (UMTS) Terrestrial Radio Access Network (EUTRAN).

The eNB 204 is connected to an Evolved Packet Core (EPC), which facilitates connection between the EUTRAN (including the eNB 204) and an Internet Protocol Packet Data Network (IP-PDN) 1001. In the example shown in FIG. 2, the IP-PDN 1001 includes a plurality of wide area networks (WANs) 210, 214 and 218. In the example shown in FIG. 2, the WAN 210 includes or provides access to a first application server 212; the WAN 214 includes or provides access to a second application server 216; and the WAN 218 includes or provides access to third and fourth application servers 220 and 222. In this example, the first application server 212 is a data storage cloud; the second application server 216 is a gaming server; the third application server is a video server 220; and the fourth application server is a File Transfer Protocol (FTP) server 222. However, example embodiments should not be limited to these examples.

Still referring to FIG. 2, as discussed above, the client devices 202 are also served by a WLAN AP 208, which provides the client devices 202 with access to the IP-PDN 1001 via a WLAN connection such as Wi-Fi or the like.

In the example embodiment shown in FIG. 2, each of the client devices 202, the eNB 204, and the WLAN AP 208 include an SDN application, and each of the EPC 206 and the WANs 210, 214 and 218 include an SDN controller. Although not explicitly shown in FIG. 2, each WAN SDN controller may be running at a WAN router within the respective WAN.

As it is generally known, SDN technology was originally designed to be deployed among switches in data centers, but its availability has been extended to routers in WANs. Using well-known communication protocols such as OpenFlow, an SDN controller may collect various networking feedback (e.g., current link capacity and/or packet loss rate on a link) from WAN routers in real-time. With such information, an SDN controller may dynamically adapt/reconfigure routing paths through the WAN in response to changes in network conditions and/or Quality of Service (QoS) rules that may be updated by service providers (e.g., Internet Service Providers (ISPs)) using SDN Northbound Application Programming Interfaces (APIs).

The SDN application (sometimes referred to herein as the eNB SDN application) 2040 at the eNB 204 and the WLAN AP SDN application 2080 at the WLAN AP 208 (sometimes referred to herein as the WLAN AP SDN application) are in communication with one or more corresponding SDN controllers. As discussed herein, the eNB 204 and the WLAN AP 208 may collectively be referred to more generically as edge nodes or wireless edge nodes. For example, the eNB SDN application 2040 and the WLAN AP SDN application 2080 are in communication with the SDN controller 2060 in the EPC 206. The SDN applications 2020 at the client devices 202 (sometimes referred to herein as the client SDN applications) are also in communication with one or more SDN controllers through the eNB 204 and/or the WLAN AP 208. The WLAN AP SDN application 2080 may also be in communication with the WAN SDN controller within the WAN 218.

In the example embodiment shown in FIG. 2, the LTE and WLAN chains merge at the packet data network (PDN) gateway (PGW), which is the interface to the public Internet and the WAN. Thus, the eNB SDN application 2040 and the WLAN AP SDN application 2080 are in communication with the SDN controller 2060 in the LTE EPC 206. In at least some other example embodiments, however, the WLAN AP SDN application 2080 may be in communication with a WLAN SDN controller residing (not shown in FIG. 0.2) between the WLAN AP 208 and the WAN SDN controllers in the WAN. Such a WLAN SDN controller coordinates multiple WLAN APs, and mirrors the SDN controller 2060 in the LTE EPC 206.

The SDN applications provide QoS policy and routing table updates at the respective client devices and/or edge nodes based on information provided by the respective SDN controllers.

According to at least some example embodiments, the client SDN application 2020 running on a client device 202 receives various networking information from at least one of the SDN controllers, and selects the most suitable connectivity path or paths for a given user application in real-time. In at least one example embodiment, to avoid scalability issues, the client device 202 may receive the information from the SDN-enabled local edge nodes, such as the WLAN AP 208 and/or eNB 204. Additional functionality of the client SDN applications 2020, as well as the SDN applications 2040 and 2080 at edge nodes 204 and 208 will be discussed in more detail later.

As it is generally known, there are different QoS requirements, depending on the characteristics of user applications. For instance, file downloading using FTP and web browsing are not latency sensitive; on the other hand, network delay is more important to real-time traffic applications, such as Voice over Internet Protocol (VoIP) and online gaming. For over-the-top (OTT) video streaming services, throughput is considered important to provide the increasingly on-demand high resolution video.

The throughput-based path control according to one or more example embodiments may improve and/or maximize downloading rates while using multi-connectivity over multiple paths. For purposes of explanation, in some instances, example embodiments will be discussed with regard to a client device 202 that is requesting content from an application server (e.g., one of servers 212, 216, 220 and 222 in FIG. 2) over two parallel paths. In this example, the first of the two connectivity paths is through the WAN 218 and the WLAN AP 208 (hereinafter sometimes referred to as the WLAN path), and the second of the two paths is through the WAN 218, the EPC 206 and the eNB 204 (hereinafter sometimes referred to as the LTE path).

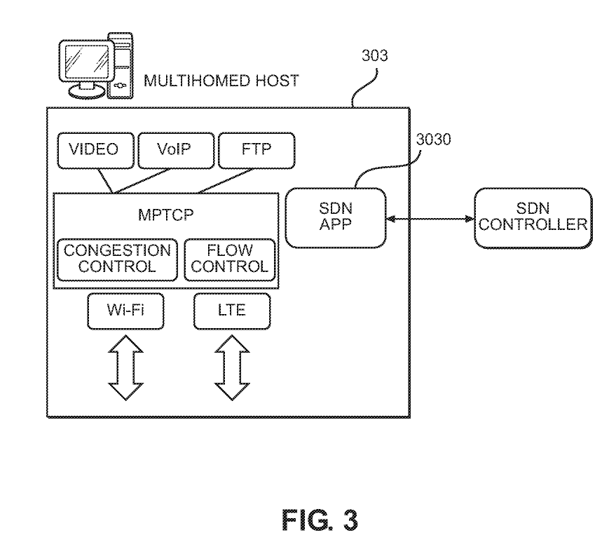

FIG. 3 illustrates a portion of an SDN framework and platform for a MPTCP client device and SDN controller, according to an example embodiment.

Referring to FIG. 3, the SDN application 3030 and the client device 303 shown in FIG. 3 are similar to the client SDN application 2020 and client device 202, respectively, shown in FIG. 3 except that the SDN application 3030 and the client device 303 are implemented with regard to the MPTCP.

In the example embodiment shown in FIG. 3, an MPTCP SDN application 3030 running on a MPTCP client device 303 retrieves various networking information from at least one SDN controller, and selects one or more suitable MPTCP paths in real-time. In at least one example embodiment, to suppress scalability issues, the MPTCP SDN application 3030 at the client device 303 may obtain the required information from (e.g., directly from) SDN-enabled local edge nodes, such as the WLAN AP 208 or eNB 204, as shown in FIG. 2.

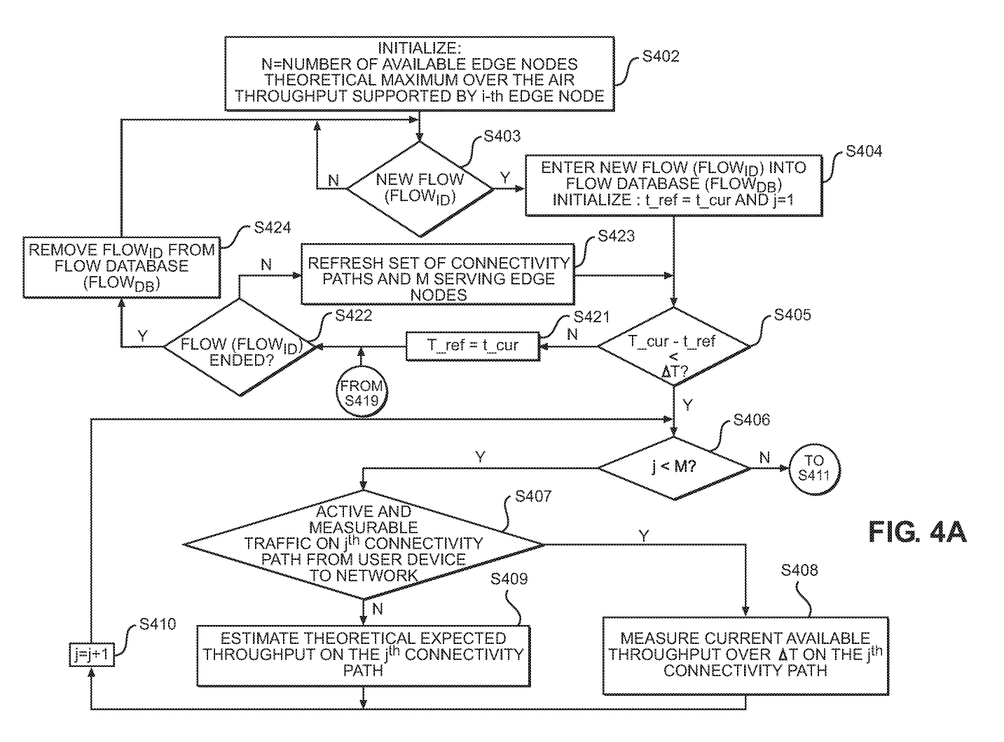

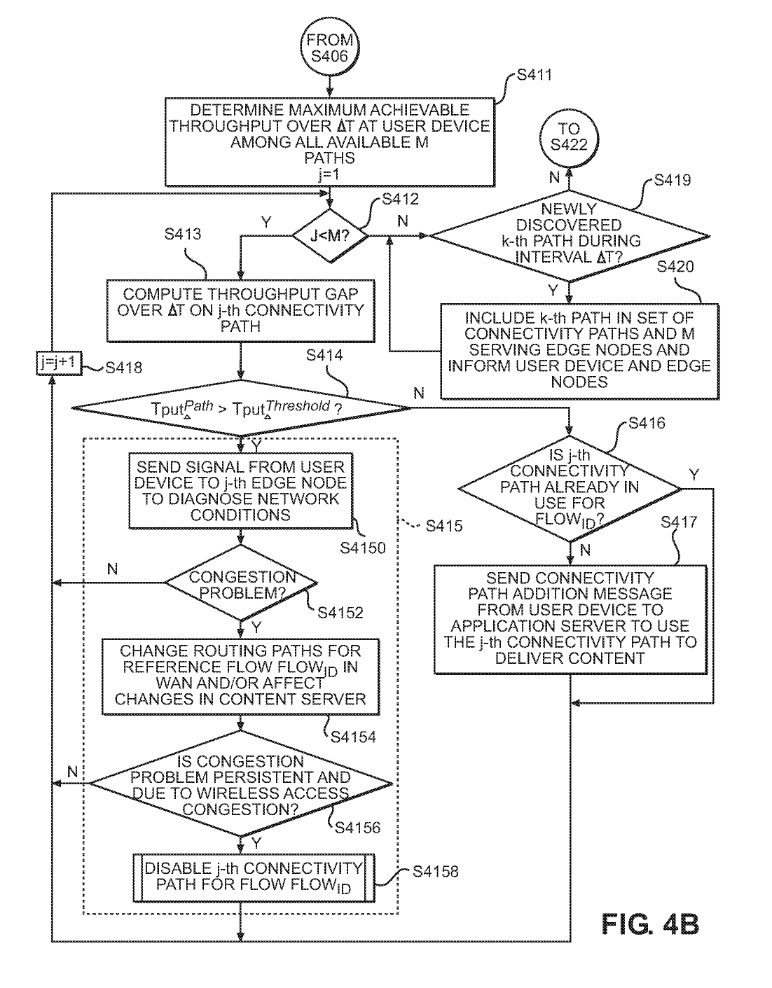

FIGS. 4A and 4B are flow charts illustrating an example embodiment of multi-connectivity path control method. The example embodiment shown in FIGS. 4A and 4B will be described with regard to the SDN framework and platform shown in FIG. 2. However, example embodiments should not be limited to this example.

According to at least some example embodiments, the intelligence described in the algorithmic flow charts shown in FIGS. 4A and 4B is distributed across multiple components, including: client SDN application 2020, SDN wireless/access edge node application 2040 and 2080, SDN wireless network controllers 2060, SDN wide area network controllers governing WAN 210, 214 and 218. In at least one example embodiment, the control may be centralized at the SDN wireless controller, in which case the required information for the decision making process may be supplied to the SDN wireless network controllers. Alternatively, some computational steps may be executed by other components (e.g., client SDN application 2020 at the client device 202 and/or the SDN applications 2040, 2080 at the wireless/access edge nodes 204, 208). The steps shown in FIGS. 4A and 4B describe an example embodiment of the algorithmic intelligence.

Referring to FIG. 4A, at step S402, the intelligence at one or more SDN wireless network controllers (e.g., SDN controller 2060 for the LTE EPC 206 and/or WLAN SDN controller for the WLAN access network (not shown in FIG. 2)) initializes the number of available edge nodes (e.g., eNodeBs and/or WLAN APs) N within the wireless network. The SDN wireless network controller also initializes and/or computes a theoretical maximum over-the-air (OTA) throughput Tputₚₐₜₕ_{ᵢ}^{Max} supported by an i^{th} edge node, where 1≦i≦N. As is generally known, this configuration information is related to the wireless system under the jurisdiction of the SDN wireless network controller(s), hence the configuration information has to be initialized within the SDN wireless network controller(s). On a need basis, the configuration information may be communicated to other components of the distributed intelligence.

In one example, as is generally known, a theoretical maximum OTA throughput Tputₚₐₜₕ_{ᵢ}^{Max} supported by a WLAN AP may be computed using the measured Received Signal Strength Indicator (RSSI) and the Modulation and Coding Scheme (MCS) information for the client device 202. Because methods for computing and/or estimating a theoretical maximum achievable throughput over connectivity paths such as this are generally known, a detailed discussion is omitted.

In another example, as is also generally known, the theoretical maximum over-the-air (OTA) throughput Tputₚₐₜₕ_{ᵢ}^{Max} supported by an eNB (also referred to as a peak data rate) may be computed based on information such as Channel Quality Indicator (CQI), MCS, bandwidth and number of antennas usable at the serving eNB 204 with respect to the architecture in FIG. 2.

At step S403, the client SDN application 2020 at the client device 202 checks whether there is a new flow Flow_{ID} that has originated from the client device 202, and which is able to communicate through a set or a subset of M wireless edge nodes, where M≦N. In at least one example, the “check” may be triggered by the client SDN application 2020. According to at least one other example embodiment, if an SDN controller (e.g., SDN controller 2060 within the EPC 206) is aware of the new flow, then the “check” at the client SDN application 2020 may be triggered by the SDN controller using any well-known signaling.

If the client SDN application 2020 determines that a new flow Flow_{ID} does not exist at step S403, then the client SDN application 2020 loops back and awaits arrival of a new flow.

Still referring to step S403, if the client SDN application 2020 determines that a new flow Flow_{ID} exists, then at step S404 the client SDN application 2020 enters the newly originated flow Flow_{ID} into a flow database Flow_{DB} maintained by the client SDN application 2020 at the client device 202. The client SDN application 2020 also communicates with the SDN controller(s) and the SDN applications at the edge nodes to update the flow databases at each of these network elements. By maintaining flow databases Flow_{DB} at respective edge nodes, the SDN application of an edge node has full visibility of the network conditions and has knowledge of the current throughput for each flow for client devices attached to the respective edge node; this allows the SDN application at the edge node to swiftly calculate expected throughputs on an as-needed basis.

Also at step S404, the client SDN application 2020 initializes the current time t_cur, the reference time t_ref and a measurement sample parameter ΔT. The current time t_cur tracks the current time in the system, and the reference time t_ref is initialized to the initial value of the t_cur value (i.e., t_ref=t_cur). The measurement sample parameter ΔT is a measurement sampling interval for measuring throughput metrics at different entities in the network. According to at least one example embodiment, the current time t_cur, the reference time t_ref and the measurement sample parameter ΔT are system time variables maintained by the network elements involved in performing the functionality discussed with regard to example embodiments.

Still referring to step S404, the client SDN application 2020 also initializes integer variable j to 1. The integer variable j tracks the connectivity path identity within the multi-connectivity context for the client device 202. In this regard, j may be an index indicative of a connectivity path between the client device 202 and an application server.

At step S405, the client SDN application 2020 determines whether the difference between an updated current time t_cur and the reference time t_ref is less than the measurement sampling interval ΔT.

If the client SDN application 2020 determines that the difference between the updated current time t_cur and the reference time t_ref is less than the measurement sampling interval ΔT at step S405, then the client SDN application 2020 checks whether the counter value j is less than the number of currently available edge nodes Mat step S406.

If the client SDN application 2020 determines that the counter value j is less than the number of currently available edge nodes M at step S406, then at step S407 the client SDN application 2020 determines whether there is active and/or measurable traffic on the j-th connectivity path from the client device 202 to the wireless network. In at least one example, the client SDN application 2020 determines that there is active and/or measureable traffic on the j-th connecting path if existing flows are using the j-th connectivity path. The client SDN application 2020 determines that there is active/measureable traffic on the j-th connecting path if there are application level packets present at the client device 202. Otherwise, the client SDN application 2020 determines that there is no active/measureable traffic on the j-th connecting path.

If the client SDN application 2020 determines that there is active and/or measurable traffic on the j-th connecting path from the client device 202 to the wireless network at step S407, then at step S408 the client SDN application 2020 measures the current available throughput Tputₚₐₜₕ_{ⱼ} on the j-th connectivity path over the measurement sampling interval ΔT, and stores the current available throughput Tputₚₐₜₕ_{ⱼ} as the reference throughput Tputⱼ for the j-th connectivity path (i.e., Tputⱼ=Tputₚₐₜₕ_{ⱼ}). The reference throughput Tputⱼ may be stored at the client device 202 in any suitable memory.

At step S410, the client SDN application 2020 increments the counter value j=j+1. The process then returns to step S406 and continues as discussed above.

Returning to step S407, if the client SDN application 2020 determines that there is no active and/or measurable traffic flowing on the j-th connectivity path between the client device 202 and the corresponding wireless edge node, then client SDN application 2020 is unable to directly measure the current available throughput on the j-th path. In this case, the client SDN application 2020 initiates and/or requests that the SDN application on the corresponding wireless edge node (e.g., eNB SDN application 2040 at the eNB 204) estimates the theoretically expected throughput Tputₚₐₜₕ_{ⱼ}^{Exp} over the measurement sampling interval ΔT for the j-th connectivity path. In one example, the client SDN application 2020 may initiate and/or request that the eNB SDN application 2040 at the eNB 204 estimates the theoretically expected throughput Tputₚₐₜₕ_{ⱼ}^{Exp}. In this example, the client SDN application 2020 may initiate and/or request that the eNB SDN application 2040 estimates the theoretically expected throughput Tputₚₐₜₕ_{ⱼ}^{Exp} using any well-known signaling.

In response to the request from the client SDN application 2020, the SDN application at the wireless edge node estimates the theoretically expected throughput Tputₚₐₜₕ_{ⱼ}^{Exp}, and stores the theoretically expected throughput Tputₚₐₜₕ_{ⱼ}^{Exp} as the reference throughput Tputⱼ for the j-th connectivity path (Tputⱼ=Tputₚₐₜₕ_{ⱼ}^{Exp}) in any suitable memory. The SDN application at the wireless edge node also communicates the theoretically expected throughput Tputₚₐₜₕ_{ⱼ}^{Exp} to the client SDN application 2020 at the client device 202, and the client SDN application 2020 stores the theoretically expected throughput Tputₚₐₜₕ_{ⱼ}^{Exp} in association with the index j for the j-th connectivity path. The SDN application at the wireless edge node may communicate the theoretically expected throughput Tputₚₐₜₕ_{ⱼ}^{Exp} to the client SDN application 2020 using any well-known signal.

Returning to FIG. 4A, after estimating the theoretically expected throughput Tputₚₐₜₕ_{ⱼ}^{Exp}, the process then proceeds to step S410 and continues as discussed above.

Returning to step S406, if the index j is greater than or equal to the number of currently available edge nodes M, then at step S411 the client SDN application 2020 determines a maximum achievable throughput Tput_{Max} among all available connectivity paths M according to Equation (1) shown below.

Tput_{Max}=Max(Tput₁,Tput₂, . . . ,Tput_{M-1},Tput_{M}) (1)

Also at step S411, the client SDN application 2020 resets the index j to 1 to track the connectivity path identity within the multi-connectivity context for the client device 202.

At step S412, the client SDN application 2020 again checks whether the index j is less than the number of currently available edge nodes M.

If the index j is less than the number of current available edge nodes M, then at step S413 the client SDN application 2020 computes a throughput gap parameter Tput_{Δ}^{path}^{ⱼ} over the measurement sampling interval ΔT for the j-th connectivity path to the wireless network based on the maximum achievable throughput Tput_{Max} and the reference throughput for the j-th connectivity path Tputⱼ. In one example, the client SDN application 2020 computes the throughput gap parameter Tput_{Δ}^{path}^{ⱼ} for the j-th connectivity path Tput_{Δ}^{path}^{ⱼ} according to Equation (2) shown below.

$${Tput}_{Δ}^{{path}_{j}} = \frac{( {Tput}_{Max} - {Tput}_{j} )}{{Tput}_{Max}} \qquad ( 2 )$$

At step S414, the client SDN application 2020 compares the throughput gap parameter Tput_{Δ}^{path}^{ⱼ} computed at step S413 with a throughput gap parameter threshold value Tput_{Δ}^{Threshold}.

If the throughput gap parameter Tput_{Δ}^{path}^{ⱼ} is greater than or equal to throughput gap parameter threshold value Tput_{Δ}^{threshold} (i.e., Tput_{Δ}^{path}^{ⱼ}≧Tput_{Δ}^{threshold}) at step S414, then at step S4150 the client SDN application 2020 sends a signal to the SDN controlling entity/entities for the wireless edge node for the j-th connectivity path to diagnose current network conditions. Depending on the implementation, the SDN controlling entity/entities receiving the signal from the client SDN application 2020 may be the SDN application at the edge node itself (e.g., 2060 at the eNB), the corresponding SDN wireless controller (e.g., 206 within the EPC), or both.

In response to the signal from the client SDN application 2020, at step S4152 the SDN controlling entity/entities involves the SDN wireless controller (e.g., 206 within the EPC), which determines whether the problem is a result of link congestion in the WAN segment. In one example, the SDN controller may contact other SDN controller(s) in the WAN segment to determine whether the problem is caused by link congestion in the WAN segment along the end-to-end path content delivery between the client device 202 and the application server. Note that if the SDN controlling entity/entities involves only the client SDN application 2020, then the SDN application, in a similar way as described above, may contact the SDN controller(s) in the WAN segment via the SDN wireless controller that is in the end-to-end path of the content delivery.

If the problem is a result of link congestion in the WAN segment, then at step S4154 the SDN controller attempts to resolve the problem by changing the routing path for the flow Flow_{ID} or by re-directing the flow to other available content server(s) that may provide better networking performance at the moment. As discussed briefly herein, an SDN controller may dynamically adapt/reconfigure routing paths through the WAN in response to changes in network conditions and/or Quality of Service (QoS) rules that may be updated by service providers (e.g., Internet Service Providers (ISPs)) using SDN Northbound Application Programming Interfaces (APIs) based on various networking feedback (e.g., current link capacity and/or packet loss rate on a link) collected from WAN routers in real-time.

After sending the signal to the SDN controller, at step S4156 the client SDN application 2020 determines whether the problem persists and whether the local wireless access network congestion is causing the problem. In one example, the client SDN application 2020 may determine whether the congestion problem persists and is a result of wireless access congestion by re-computing the throughput gap parameter Tput_{Δ}^{path}^{ⱼ} as discussed above with regard to step S413, and re-comparing the throughput gap parameter Tput_{Δ}^{path}^{ⱼ} with the throughput gap parameter threshold value Tput_{Δ}^{threshold}. In this example, if the re-computed throughput gap parameter Tput_{Δ}^{path}^{ⱼ} is still greater than or equal to throughput gap parameter threshold value Tput_{Δ}^{threshold} (i.e., Tput_{Δ}^{path}^{ⱼ}≧Tput_{Δ}^{threshold}), then the congestion problem may be considered persistent and due to congestion in the wireless access network. If the re-computed throughput gap parameter Tput_{Δ}^{path}^{ⱼ} is less than the throughput gap parameter threshold value Tput_{Δ}^{threshold} (i.e., Tput_{Δ}^{path}^{ⱼ}<Tput_{Δ}^{Threshold}), then the congestion problem has been resolved and is not due to wireless access congestion.

Still referring to step S4156, if the client SDN application 2020 determines that the problem is resolved, and the local wireless access network congestion is not the cause of the congestion problem, then the client SDN application 2020 increments the index j=j+1 at step S418. The process then returns to step S412, and continues as discussed above.

If, however, the client SDN application 2020 determines that the congestion problem has not been resolved at step S4156, then the client SDN application 2020 removes, disconnects and/or disables the j-th connectivity path for the flow Flow_{ID} at step S4158.

As shown in FIG. 4B, steps S4150 through S4158 are collectively identified as step S415. Step S415 in FIG. 4B may collectively be referred to as a method for controlling congestion.

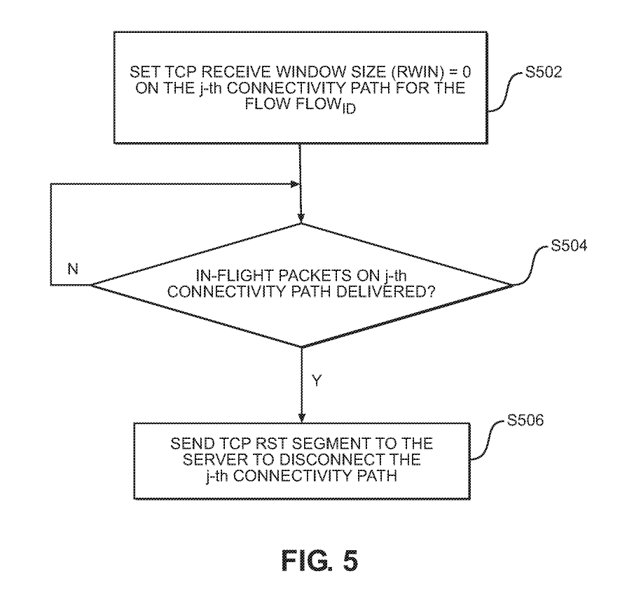

In an example in which the flow is a MPTCP flow, the client SDN application 2020 may remove, disconnect and/or disable the j-th connectivity path by sending a TCP RST message segment to the application server associated with the flow Flow_{ID} over the j-th connectivity path. However, in this case, the in-flight packets on the j-th connectivity path may be lost and would need to be resent again over another connectivity path. In an effort to reduce re-transmission of these in-flight packets, the client SDN application 2020 may utilize the method shown in FIG. 5.

FIG. 5 is a flow chart illustrating an example embodiment of a method for removing, disconnecting and/or disabling the j-th connectivity path between a client device and an application server. For example purposes, the flow chart shown in FIG. 5 will be discussed with regard to the framework shown in FIG. 2.

Referring to FIG. 5, at step S502 the client SDN application 2020 sets the TCP Receive Window size (RWIN) for the j-th connectivity path to zero, which halts further TCP transmission over the j-th connectivity path.

At step S504, the client SDN application 2020 checks whether all in-flight packets on the j-th connectivity path have been delivered to the client device 202.

If, at step S504, the client SDN application 2020 determines that all in-flight packets on the j-th connectivity path have not been delivered to the client device 202, then the client SDN application 2020 loops back and awaits delivery of the remaining in-flight packets to the client device 202.

If, at step S504, the client SDN application 2020 determines that all in-flight packets on the j-th connectivity path have been delivered, then the client SDN application 2020 sends the TCP RST message segment to disconnect the j-th connectivity path at step S506.

Returning to FIGS. 4A and 4B, after disabling the j-th connectivity path for the flow Flow_{ID} at step S4158, the process proceeds to step S418 and continues as discussed above.

Returning to step S414, if the throughput gap parameter Tput_{Δ}^{path}^{ⱼ} is less than the throughput gap parameter threshold value Tput_{Δ}^{threshold} (i.e., Tput_{Δ}^{path}^{ⱼ}<Tput_{Δ}^{threshold}), then the client SDN application 2020 determines that the throughput corresponding to the j-th connectivity path between the client device 202 and the corresponding wireless edge node is above an acceptable level to warrant inclusion (or continued inclusion) within the set or subset of M paths for the flow Flow_{ID}.

At step S416, the client SDN application 2020 determines whether the j-th connectivity path is already in use by the flow Flow_{ID}.

If the j-th connectivity path is already in use by the flow Flow_{ID}, then the throughput on the j-th connectivity path was measured by the client SDN application 2020 at step S408. On the other hand, if the j-th connectivity path is not in use by the flow Flow_{ID}, then the throughput on the j-th connectivity path was estimated at the eNB SDN application 2040 on the wireless edge node 204 at step S409. Accordingly, in one example, the client SDN application 2020 may determine whether the j-th connectivity path is already in use by the flow Flow_{ID} according to whether active and/or measurable traffic was present on the j-th connectivity path at step S407.

If the client SDN application 2020 determines that the j-th connectivity path is already in use by the flow Flow_{ID} at step S416, then the process proceeds to step S418 and continues as discussed above.

Returning to step S416, if the client SDN application 2020 determines that the j-th connectivity path is not in use by the flow Flow_{ID}, then at step S417 the client SDN application 2020 sends a connectivity path addition message to the application server to add the j-th connectivity path for data transmission between the application server and the client device 202. In one example, the connectivity path addition message may be a MP_JOIN message.

The connectivity path addition message to the application server to use the j-th connectivity path for data transmission enables the flow Flow_{ID} from the application server to be carried over the j-th connectivity path.

Still referring to step S417, the client SDN application 2020 also sends a message to the SDN application on each wireless edge node and to the SDN wireless controller(s) it can communicate with to update their respective flow database Flow_{DB} with the new connectivity path for the flow Flow_{ID}. The process then proceeds to step S418 and continues as discussed above.

Note that in the case when there are multiple flows delivered in parallel to the same client device (e.g., a video flow and a data flow), according to at least one example embodiment, each flow may be mapped to a separate source port on the client device, and the delivery path may be associated with the respective 4-tuple (source and destination IP addresses and TCP port pairs) to which the flow is mapped.

In this example, the j-th connectivity path may not be currently in use by the flow Flow_{ID}, but after estimating relatively good throughput conditions over the j-th connectivity path (e.g., at step S409), the client SDN application 2020 may establish a new TCP subflow (with its own source port) over the j-th connectivity path for the flow Flow_{ID}, while maintaining connectivity for other parallel flows, which have their own ports.

According to one or more example embodiments in which flows are MPTCP flows, creating new MPTCP subflows includes obtaining a TCP source port number from the Operating System (OS) and establishing a TCP connection to the server. Since methods for obtaining TCP source port numbers and establishing TCP connections are generally well-known, a detailed discussion is omitted.

Returning now to step S412 in FIG. 4B, if the client SDN application 2020 determines that the index j is greater than or equal to the number of current available edge nodes M, then the client SDN application 2020 checks whether a new k-th path has been discovered during the latest measurement interval ΔT, according to wireless edge nodes discovery procedures that are specific to the underlying technologies. Because such discovery procedures are generally known, a detailed discussion is omitted.

If the client SDN application 2020 identifies a new k-th path during the measurement interval ΔT at step S419, then at step S420 the client SDN application 2020 includes the newly discovered k-th path within the set of connectivity paths and M serving edge nodes. The client SDN application 2020 also communicates with the SDN applications on the wireless edge nodes and the SDN controller(s) it can communicate with to update their respective flow databases at the respective network elements with the k-th path information. The client SDN application 2020 may communicate with the SDN applications on the wireless edge nodes and SDN controller(s) using any well-known signaling.

According to at least some example embodiments, the algorithm exercised through the client SDN application 2020 includes the newly discovered k-th path within the set of connectivity paths and M serving edge nodes. If, however, the new k-th path is associated with a new wireless edge node that is not in the set of M edge nodes, then the client SDN application 2020 increments the value of M (M=M+1).

Returning to step S419 in FIG. 4B, if the client SDN application 2020 does not discover a new path, then the client SDN application 2020 determines whether the flow Flow_{ID} has ended at step S422. Because methods for determining whether flows such as flow Flow_{ID} are generally known as for any typical traffic flow that is handled by a traditional transport protocol (e.g., TCP connection termination procedure which involves the TCP FIN message), further discussion is omitted.

If the client SDN application 2020 determines that the flow Flow_{ID} has ended at step S422, then the client SDN application 2020 removes the flow Flow_{ID} from the flow database Flow_{DB} at the client device 202 at step S424. Also at step S424, the client SDN application 2020 communicates with the SDN applications at the wireless edge nodes and the SDN controller(s) to remove the flow Flow_{ID} from the flow databases at the respective network elements. The client SDN application 2020 may communicate with the SDN applications on the wireless edge nodes and SDN controller(s) using any well-known signaling.

Returning to step S422 in FIG. 4A, if the client SDN application 2020 determines that the flow Flow_{ID} has not ended, then the client SDN application 2020 refreshes the connectivity configuration for the client device 202 at step S423. In at least one example embodiment, the client SDN application 2020 may add and/or drop connectivity paths and serving edge nodes in the set of M edge nodes as a result of mobility of the client device 202. The refreshing at step S423 enables the client SDN application 2020 to account for the adding and/or dropping of connectivity paths and serving edge nodes. In case of any such update, the client SDN application 2020 updates its own database with the refreshed connectivity information for the affected flows, and informs in turn the SDN applications at the wireless edge nodes and the SDN controller(s) it can communicate with to update their own databases for the affected flows. The client SDN application 2020 may communicate with the SDN applications on the wireless edge nodes and SDN controller(s) using any well-known signaling.

After refreshing the connectivity configuration at step S423, the process proceeds to step S405 and continues as discussed herein.

As discussed above, at step S405, if the client SDN application 2020 determines that the difference between the updated current time t_cur and the reference time t_ref is less than the measurement sampling interval ΔT, then the client SDN application 2020 checks whether the counter value j is less than the number of currently available edge nodes Mat step S406.

If, on the other hand, the client SDN application 2020 determines that the difference between the updated current time t_cur and the reference time t_ref is greater than or equal to the measurement sampling interval ΔT at step S405, then the client SDN application 2020 updates the reference time t_ref with the current time t_cur (t_ref=t_cur) at step S421. The process then proceeds to step S422 and continues as discussed above.

According to one or more example embodiments, throughput gap parameter threshold value Tput_{Δ}^{threshold} may be adjusted over time (e.g., through a control loop). As a result, throughput gap parameter threshold value Tput_{Δ}^{threshold} may be increased (e.g., more conservative, wherein poorer links are dropped faster) or decreased (e.g., more aggressive, wherein poorer links are dropped more slowly) to improve and/or maximize throughput performance. In yet another example embodiment, different throughput gap parameter threshold values may be used for adding (Tput_{Δ}^{Threshold}^{_}^{AddPath}) and dropping (Tput_{Δ}^{Threshold}^{_}^{DropPath}) connectivity paths.

For the sake of clarity, a more specific and simplified example will now be provided with regard to the framework shown in FIG. 2. In the following example, the client SDN application 2020 is provided with two paths, a first path traversing the WLAN AP 208 and a second path traversing the eNB 204. As discussed herein, the first path may be referred to as a WLAN path and the second path may be referred to as a LTE path.

In this example, the framework includes two serving wireless edge nodes (i.e., M=2); that is, the eNB 204 and the WLAN AP 208. Further, in this example, the SDN application at the wireless network controller initializes a theoretical maximum over-the-air (OTA) throughput Tput_{LTE}^{Max} supported by the eNB 204 and a theoretical maximum over-the-air (OTA) throughput Tput_{WLAN}^{Max} supported by the WLAN AP 208.

As discussed similarly above, the theoretical maximum OTA throughput Tput_{WLAN}^{Max} supported by the WLAN AP 208 may be computed using the measured Received Signal Strength Indicator (RSSI) and the Modulation and Coding Scheme (MCS) information for the client device 202.

As also discussed similarly above, the theoretical maximum over-the-air (OTA) throughput Tput_{LTE}^{Max} supported by the eNB 204 (also referred to as a peak data rate) may be computed based on information such as Channel Quality Indicator (CQI), MCS, bandwidth and number of antennas usable at the eNB 204.

The WLAN AP SDN application 2080 at the WLAN AP 208 estimates the theoretically expected throughput Tput_{WLAN}^{Exp} for the WLAN path through the WLAN AP 208, and the eNB SDN application 2040 at the eNB 204 estimates the theoretically expected throughput Tput_{LTE}^{Exp} for the LTE path through the eNB 204 with the support of the corresponding SDN controllers.

In one example, assuming that there are L established flows coming from L different users through the WLAN path, the WLAN AP SDN application 2080 at the WLAN AP 208 may calculate the theoretically expected throughput Tput_{WLAN}^{Exp} for the client device 202 over the WLAN path according to Equation (3) shown below.

Tput_{WLAN}^{Exp}=Min(Tput_{WLAN}^{WAN},Tput_{WLAN}^{Local}) (3)

In Equation (3), the throughput Tput_{WLAN}^{Local} is a function of the theoretical maximum achievable throughput Tput_{WLAN}^{Max} at the client device 202 over the WLAN path and the aggregate current over-the-air (OTA) throughput Tput_{WLAN}^{User}^{ᵢ} usage by other (L−1) users served by the WLAN AP 208 as shown below in Equation (4).

Tput_{WLAN}^{Local}=Tput_{WLAN}^{Max}−Σᵢ₌₁^{L-1}Tput_{WLAN}^{User}^{ᵢ} (4)

Similarly, assuming that there are P established flows coming from P different users through the LTE path, the eNB SDN application 2040 at the eNB 204 may calculate the theoretically expected throughput Tput_{LTE}^{Exp} for the client device 202 over the LTE path according to Equation (5) shown below.

Tput_{LTE}^{Exp}=Min(Tput_{LTE}^{Local}) (5)

In Equation (5), the throughput Tput_{LTE}^{Local} is a function of the theoretical maximum achievable throughput Tput_{LTE}^{Max} at the client device 202 over the LTE path and the aggregate current over-the-air (OTA) throughput Tput_{LTE}^{User}^{ᵢ} usage by other (P−1) users served by the eNB 204 as shown below in Equation (6).

Tput_{LTE}^{Local}=Tput_{LTE}^{Max}−Σᵢ₌₁^{P-1}Tput_{LTE}^{User}^{ᵢ} (6)

Since experimental results have shown that MPTCP causes relatively poor performance due to increased size of reordering queue under relatively heavily unbalanced traffic load conditions, before utilizing a multi-connectivity protocol (e.g., MPTCP) over the WLAN and LTE paths in FIG. 2, the client SDN application 2020 checks if the current or available throughput over the WLAN and LTE paths are significantly different by calculating a throughput gap parameter Tput_{Δ} (also referred to as the throughput gap) based on the theoretical maximum throughput for each of the LTE and WLAN paths as shown below in Equation (7).

$${Tput}_{Δ} = \frac{\vert {Tput}_{LTE}^{Max} - {Tput}_{WLAN}^{Max} \vert}{Max ( {Tput}_{LTE}^{Max} , {Tput}_{WLAN}^{Max} )} \qquad ( 7 )$$

Additionally, the throughput gap for the WLAN path Tput_{Δ}^{WLAN} and the throughput gap for the LTE path Tput_{Δ}^{LTE} with respect to the maximum throughput Tput_{Max} across the two paths is given by Equations (8) and (9) shown below.

$$\begin{matrix}{Tput}_{Δ}^{LTE} = \frac{( {Tput}_{Max} - {Tput}_{LTE} )}{{Tput}_{Max}} & ( 8 ) \\ {Tput}_{Δ}^{WLAN} = \frac{( {Tput}_{Max} - {Tput}_{WLAN} )}{{Tput}_{Max}} & ( 9 )\end{matrix}$$

In Equations (8) and (9), the maximum throughput Tput_{Max} across the two paths is given by Equation (10) shown below.

Tput_{Max}=Max(Tput_{LTE}^{Max},Tput_{WLAN}^{Max}) (10)

In at least one example embodiment, if the computed throughput gaps over both the LTE path Tput_{Δ}^{LTE} and the WLAN path Tput_{Δ}^{WLAN} are less than the tunable throughput gap parameter threshold value Tput_{Δ}^{threshold}, both paths are used by the multi-connectivity protocol (e.g., MPTCP). Otherwise, the path with the larger throughput among the two paths is used.

Once the path decisions are complete, at least the client SDN application 2020 at the client device 202 and the SDN applications 2040 and 2080 at the eNB 204 and the WLAN AP 208, respectively, update the traffic information such as the application identification and the connected paths in their local databases (e.g., Flow_{DB}). The client SDN application 2020 at the client device 202 continually monitors the current throughput on the connectivity paths (e.g., LTE and/or WLAN paths) while the client device 202 is downloading content (e.g., streaming audio and/or video, during a telephone call).

According to at least one example embodiment, when the throughput gap Tput_{Δ} across the connectivity paths becomes larger than the tunable throughput gap parameter threshold value Tput_{Δ}^{threshold}, the client SDN application 2020 at the client device 202 sends a signal to the SDN controller for an edge node to diagnose the network conditions. The SDN controller for the edge node may contact other SDN controller(s) in the WAN segment to determine whether the problem is a result of link congestion in the WAN segment along the end-to-end path between the client device and server. If this is the case, as discussed above, the problem may be resolved either by changing the routing path by the SDN controller(s) or by re-directing the flow to other available content server(s) that may provide better networking performance at the moment.

If after this diagnosis, the problem persists and is a result of local wireless access network congestion, the client SDN application 2020 at the client device 202 may re-calculate the throughput gap parameters to adjust the number of multi-connectivity (e.g., MPTCP) paths with the support of the SDN controller. In one example, the client SDN application 2020 on the client device 202 may remove and/or disable the LTE path if the computed throughput gap Tput_{Δ}^{LTE} is larger than the threshold. In one example, to remove and/or disable the path, the client SDN application 2020 on the client device 202 may send a TCP RST segment over the connected LTE path. However, in this case, the in-flight packets through the LTE path may be lost and would need to be resent again over the WLAN path. Accordingly, in at least one example embodiment, the client SDN application 2020 sets the RWIN (TCP Receive Window) size to zero, which causes the TCP transmission over the LTE path to be halted. After all in-flight packets are delivered, the client SDN application 2020 on the client device 202 sends the TCP RST segment to disconnect the LTE path.

For an example case in which a new WLAN path characterized by Tput_{WLAN2} is attached during a download (e.g., as a result of the mobility of the client device 202), the client SDN application 2020 on the client device 202 obtains the theoretically expected throughput Tput_{WLAN2}^{Exp} for the new WLAN path from the SDN application in the newly WLAN AP (not shown).

If the throughput gap over the newly found WLAN path Tput_{Δ}^{WLAN2} is less than the tunable throughput gap parameter threshold value Tput_{Δ}^{threshold}, then the client SDN application 2020 on the client device 202 adds the new path using, for example, a MP JOIN option as described above with regard to FIG. 1. The client device 202 is then able to receive data via the newly found WLAN path.

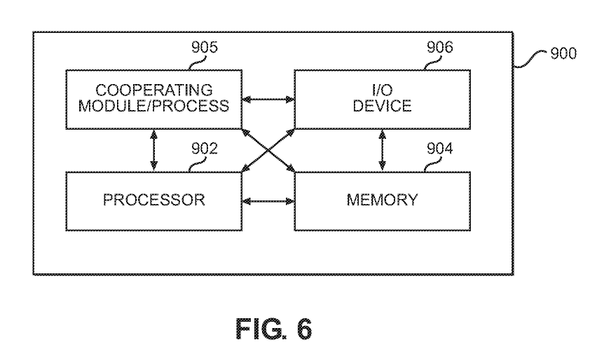

FIG. 6 depicts a high-level block diagram of a computer or computing device suitable for use in performing the operations and methodology described herein. The computer 900 includes one or more processors 902 (e.g., a central processing unit (CPU) or other suitable processor(s)) and a memory 904 (e.g., random access memory (RAM), read only memory (ROM), and the like).

The computer 900 also may include a cooperating module/process 905. The cooperating process 905 may be loaded into memory 904 and executed by the processor 902 to implement functions as discussed herein and, thus, cooperating process 905 (including associated data structures) can be stored on a computer readable storage medium, e.g., RAM memory, magnetic or optical drive or diskette, and the like.

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 900 depicted in FIG. 6 provides a general architecture and functionality suitable for implementing functional elements described herein or portions of functional elements described herein. For example, the computer 900 provides a general architecture and functionality suitable for implementing one or more of a client device, an eNB, small cell, SGW, MME, PGW, network element, network entity which hosts the methodology for described herein according to the principles of the invention, application server, WAN router, WLAN AP, and the like. For example, a processor of a router, Gateway or network node in communication a Gateway may be configured to provide functional elements that implement in the functionality discussed herein.

One or more example embodiments may be more resilient and/or suitable for mobile environments. One or more example embodiments may also supress and/or eliminate drawbacks in the state of the art MPTCP-based solutions, allow for improved end-user experience (e.g., better throughput, session continuity, etc.) and/or better use of network resources. Furthermore, one or more example embodiments may also allow a mobile client to more swiftly discover new connectivity paths and consider them for the data transmission while removing and/or dropping obsolete connectivity paths when deemed necessary.

One or more example embodiments address the requirements of mobile clients while preserving the benefits of the multi-connectivity protocols such as MPTCP. One or more example embodiments allow mobile devices to benefit from multi-connectivity while continuously adapting its configuration to the most reliable paths with assistance provided by the intelligence of the future programmable wireless networks.

According to one or more example embodiments, the available capacity of connecting paths (all of them or a preferential sub-set) between a server and a client device is tracked, and the most appropriate connectivity paths are selected depending on varying network conditions, which may be triggered either by network events, or mobility of client devices.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

What is claimed is:

1. A radio access network element comprising:
at least one transceiver configured to transmit and receive content associated with at least one packet communication protocol connection traversing at least a first wireless network and a second wireless network; and
at least one processor coupled to the at least one transceiver, the at least one processor configured to execute computer readable instructions to
determine a first available throughput for a first path traversing the first wireless network,
determine a second available throughput for a second path traversing the second wireless network,
establish, for the at least one packet communication protocol connection, at least one of a first multipath packet flow via the first path and a second multipath packet flow via the second path based on (i) a throughput gap threshold value and (ii) a throughput gap parameter for the first and second paths, the throughput gap parameter indicative of a difference between the first available throughput and the second available throughput.

2. The radio access network element of claim 1, wherein the at least one processor is further configured to execute computer-readable instructions to
establish the first multipath packet flow and the second multipath packet flow if the throughput gap parameter is less than the throughput gap threshold value.

3. The radio access network element of claim 1, wherein
the first available throughput is greater than the second available throughput; and
the at least one processor is further configured to execute computer-readable instructions to establish only the first multipath packet flow if the throughput gap parameter is greater than the throughput gap threshold value.

4. The radio access network element of claim 1, wherein
the first available throughput is an estimated throughput capacity on the first path traversing the first wireless network; and
the second available throughput is an estimated throughput capacity on the second path traversing the second wireless network.

5. The radio access network element of claim 1, wherein the at least one processor is further configured to execute computer readable instructions to
monitor the throughput gap parameter based on updated traffic information for the first and second wireless networks; and
selectively connect and disconnect at least one of the first and second paths based on the monitored throughput gap parameter.

6. The radio access network element of claim 5, wherein
the first available throughput is greater than the second available throughput; and
the at least one processor is further configured to execute computer readable instructions to
determine that the monitored throughput gap parameter exceeds the throughput gap threshold; and
disconnect the second path from the at least one packet communication protocol connection in response to determining that the monitored throughput gap parameter exceeds the throughput gap threshold value.

7. The radio access network element of claim 6, wherein the at least one processor is further configured to execute computer readable instructions to
set a receive window size for the second path to zero; and
send a path disconnect message to disconnect the second path from the at least one packet communication protocol connection in response to determining that all in-flight packets on the second path have been received at the radio access network element.

8. The radio access network element of claim 1, wherein the at least one packet communication protocol connection is a Multi-Path Transmission Control Protocol (MPTCP) connection.

9. A radio access network element comprising:
at least one transceiver configured to receive content associated with at least one packet communication protocol connection via at least a first connectivity path through a first wireless edge node and a second connectivity path through a second wireless edge node; and
at least one processor coupled to the at least one transceiver, the at least one processor configured to execute computer readable instructions to
compute at least one throughput gap parameter for the first and second connectivity paths based on a maximum throughput supported by each of the first and second wireless edge nodes and a maximum throughput across the first and second connectivity paths; and
selectively enable and disable at least one of the first and second connectivity paths for receiving the content associated with the at least one packet communication protocol connection based on the computed at least one throughput gap parameter and a throughput gap threshold value for the at least one packet communication protocol connection.

10. The radio access network element of claim 9, wherein the at least one processor is further configured to execute computer readable instructions to
compare the computed at least one throughput gap parameter with the throughput gap threshold value; and
selectively enable and disable one of the first and second connectivity paths based on the comparison.

11. The radio access network element of claim 10, wherein
the maximum throughput supported by the first wireless edge node is greater than the maximum throughput supported by the second wireless edge node; and
the at least one processor is further configured to execute computer readable instructions to disable the second connectivity path when the computed throughput gap parameter exceeds the throughput gap threshold value.

12. The radio access network element of claim 11, wherein the at least one processor is further configured to execute computer readable instructions to
re-compute the at least one throughput gap parameter for the first and second connectivity paths;
compare the re-computed at least one throughput gap parameter with the throughput gap threshold value; and
re-enable the second connectivity path if the re-computed at least one throughput gap parameter is below the throughput gap threshold value.

13. The radio access network element of claim 11, wherein the at least one processor is further configured to execute computer readable instructions to
determine whether all in-flight packets on the second connectivity path have been received at the radio access network element; and
disable the second connectivity path only after all in-flight packets on the second connectivity path have been received at the radio access network element.

14. The radio access network element of claim 9, wherein the at least one packet communication protocol connection is a Multi-Path Transmission Control Protocol (MPTCP) connection.

15. A radio access network element comprising:
at least one transceiver configured to receive content associated with at least one packet communication protocol connection via at least a first connectivity path through a first wireless edge node and a second connectivity path through a second wireless edge node; and
at least one processor coupled to the at least one transceiver, the at least one processor configured to execute computer readable instructions to
compute a first throughput gap parameter for the first connectivity path based on a first expected throughput and a first maximum throughput supported by the first wireless edge node;
compute a second throughput gap parameter for the second connectivity path based on a second expected throughput and a second maximum throughput supported by the second wireless edge node; and
selectively enable and disable at least one of the first and second connectivity paths for receiving the content associated with the at least one packet communication protocol connection based on the computed first and second throughput gap parameters and a throughput gap threshold value for the at least one packet communication protocol connection.

16. The radio access network element of claim 15, wherein
the first expected throughput is greater than the second expected throughput; and
the at least one processor is further configured to execute computer readable instructions to
compare the first throughput gap parameter with the throughput gap threshold value,
compare the second throughput gap parameter with the throughput gap threshold value, and
disable the second connectivity path if the second throughput gap parameter exceeds the throughput gap threshold value.

17. The radio access network element of claim 16, wherein the at least one processor is further configured to execute computer readable instructions to enable the first and second connectivity paths if the first and second throughput gap parameters fall below the throughput gap threshold value.

18. The radio access network element of claim 16, wherein the at least one processor is further configured to execute computer readable instructions to
re-compute the second throughput gap parameter for the second connectivity path; and
re-enable the second connectivity path if the re-computed second throughput gap parameter falls below the throughput gap threshold value.

19. The radio access network element of claim 15, wherein the at least one packet communication protocol connection is a Multi-Path Transmission Control Protocol (MPTCP) connection.
